(19) United States
(12) Patent Application Publication
(10) Pub. No.: US 2014/0309906 A1
(43) Pub. Date: Oct. 16, 2014

(54) PRESSURE DETERMINING METHOD AND MOTOR VEHICLE

(71) Applicant: Ford Global Technologies, LLC, Dearborn, MI (US)

(72) Inventors: Klemens Grieser, Langenfeld (DE); Jens Wojahn, Bergisch Gladbach (DE); Oliver Berkemeier, Bergisch Gladbach (DE); Kay Hohenboeken, Koeln (DE); Jan Linsel, Cologne (DE)

(73) Assignee: Ford Global Technologies, LLC, Dearborn, MI (US)

(21) Appl. No.: 14/217,062

(22) Filed: Mar. 17, 2014

(30) Foreign Application Priority Data
Apr. 11, 2013 (DE) 102013206424.1

(51) Int. Cl. F02D 41/38; F02M 65/00

(52) U.S. Cl. CPC F02D 41/3809; F02M 65/00
USPC 701/103; 73/114.51

(57) ABSTRACT

A pressure determining method is provided for a fuel distribution rail of an injection system of a motor vehicle comprising maximizing the fuel rail pressure to minimize particulate emissions of the engine. The method determines a setpoint pressure based on a calculation pressure being determined from a sum of a combustion chamber pressure and a square of a ratio of a fuel mass component and a pulse width, wherein the calculation pressure is output, at least temporarily, as the setpoint pressure.

### CROSS REFERENCE TO RELATED APPLICATIONS

The present application claims priority to German Patent Application No. 102013206424.1, filed on Apr. 11, 2013, the entire contents of which are hereby incorporated by reference for all purposes.

### BACKGROUND/SUMMARY

Fuel distribution rail systems may be used in various types of multiple cylinder engines, such as supercharged direct injection gasoline engines. The fuel rail is used to inject fuel into the combustion chambers via an injection nozzle. The fuel to be injected is subject to the fuel distribution rail pressure in the fuel distribution rail and injection nozzle. Coking of the fuel injectors may occur during operation of the fuel distribution rail. Injector coking contributes significantly to particulate emission.

In known injection systems, a setpoint pressure in the fuel distribution rail is determined based on predefined characteristic diagrams, typically based on actual engine load and rpm. The setpoint pressure is optimized such that the actual injection pulse width does not fall below a minimal allowed fuel pulse width. Thus, a maximum possible fuel distribution rail pressure for the situation is not frequently selected.

The inventors herein have identified potential issues with the above approach. By optimizing the setpoint pressure in order that the minimum possible pulse width of the injection is not undershot, the performance potential of the engine is therefore not exhausted. Further, by not selecting the maximum possible fuel distribution rail pressure, the mitigation of injector tip coking may not be maximized.

The inventors have recognized the above mentioned issues and developed a method for maximizing the fuel rail pressure to mitigate injector tip coking and reduce particulate emissions of the engine. The method comprises determining a setpoint pressure in a fuel distribution rail of an injection system of a motor vehicle based on a calculation pressure being determined from a sum of a combustion chamber pressure and a square of a ratio of a fuel mass component and a pulse width, and outputting the calculation pressure, at least temporarily, as the setpoint pressure.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a motor vehicle according to the present application,

FIG. 2 shows a detailed view of the motor vehicle, and

FIG. 3 shows a pressure determining method according to the present application.

### DETAILED DESCRIPTION

The present application relates to a method for determining a setpoint pressure in a fuel distribution rail of an injection system of a motor vehicle, and to a motor vehicle for carrying out the pressure determining method.

It is known to inject fuel directly into the combustion chamber in internal combustion engines. To this end, injection systems comprising injection nozzles may be connected to a fuel distribution rail.

In known injection systems, for example in injection systems of supercharged direct injection gasoline engines, the setpoint pressure in the fuel distribution rail is determined based on predefined characteristic diagrams. In this type of setpoint pressure determining, determining has to be carried out with a relatively great safety margin, in order that the minimum possible pulse width of the injection is not undershot. It thus occurs frequently that the maximum possible fuel distribution rail pressure for the situation is not selected. The performance potential of the engine is therefore not exhausted. In addition, it may lead to coking of the injection nozzle and to increased particle production.

The present application is based on reducing these disadvantages by providing a pressure determining method and a motor vehicle which is suitable for carrying out said pressure determining method.

This may be achieved by way of a pressure determining method.

In one example of the pressure determining method comprising determining a setpoint pressure in a fuel distribution rail of an injection system of a motor vehicle, a calculation pressure is determined from a sum of a combustion chamber pressure and a square of a ratio of a fuel mass component and a pulse width. The calculation pressure is output at least temporarily as setpoint pressure. A control system thus adjusts pump operation and other operating parameters to provide the setpoint pressure responsive to measured fuel rail pressure among other parameters.

Instead of the use of a characteristic diagram for the setpoint pressure in the fuel distribution rail, the setpoint pressure is based on the minimum permissible injection pulse width, resulting in the injection times being as short as possible and the injection pressures being as high as possible. Coking of the injection nozzle and particle formation may be reduced in this way by adjusting a fuel rail pressure based on a minimum pulse width clipped to a maximum value. The particle emission, in particular in the case of gasoline direct injection engines, may be lowered.

In one embodiment of the pressure determining method, the calculation pressure is compared with a maximum pressure. In the case where the calculation pressure is lower than the maximum pressure, the calculation pressure is output as setpoint pressure. In the case where the calculation pressure is greater than or equal to the maximum pressure, the maximum pressure is output as setpoint pressure.

The injection system is protected in this way against damage as a result of excessively high fuel distribution rail pressures.

In another embodiment of the pressure determining method, the ratio of the fuel mass component and the pulse width is provided with an equalization factor.

This makes simple adaptation of the method to different vehicle types possible. Different parameters which exist on account of different designs of the engines and the injection system may be taken into consideration in this way.

The motor vehicle according to the present application comprises an engine having at least one combustion chamber and an injection system having a pressure unit, a fuel distribution rail and an injection nozzle for the direct injection of fuel into the at least one combustion chamber. In addition, the motor vehicle according to the present application has a control unit which is connected in a data-transmitting manner to the engine and the injection system. According to the present application, the control unit is configured in such a way as to carry out the pressure determining method according to the present application in each of its embodiments.

The advantages of the pressure determining method thus benefit the motor vehicle. Coking of the injection nozzles of the motor vehicle may be at least reduced in this way. The motor vehicle may have an increased exhaust gas quality and meet stricter threshold value regulations with regard to the exhaust gas quality.

Exemplary embodiments of the present application will be explained in greater detail using the drawings and the following description.

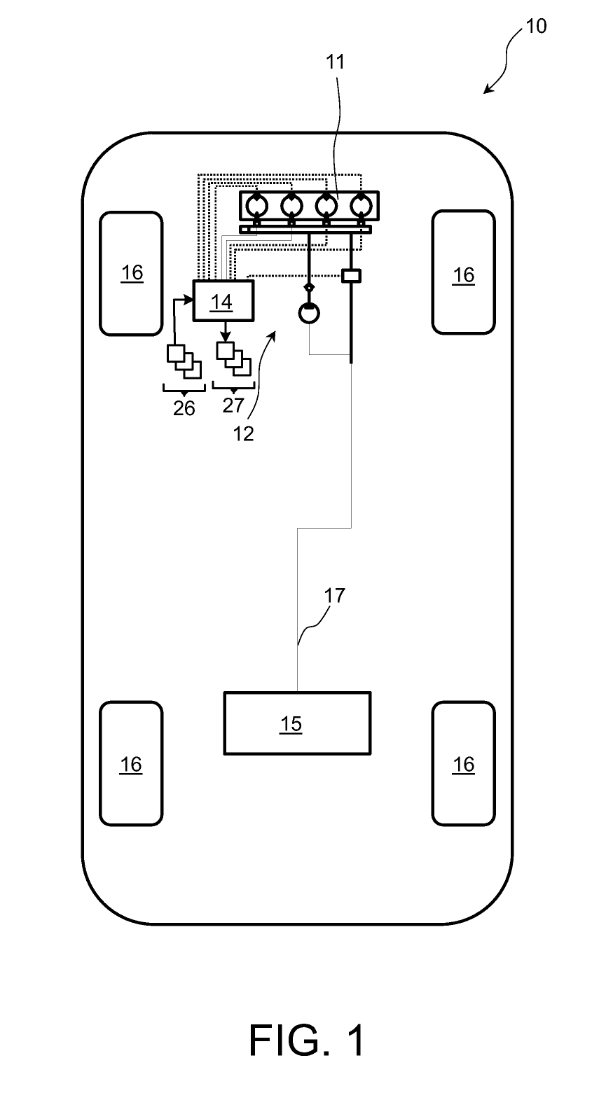

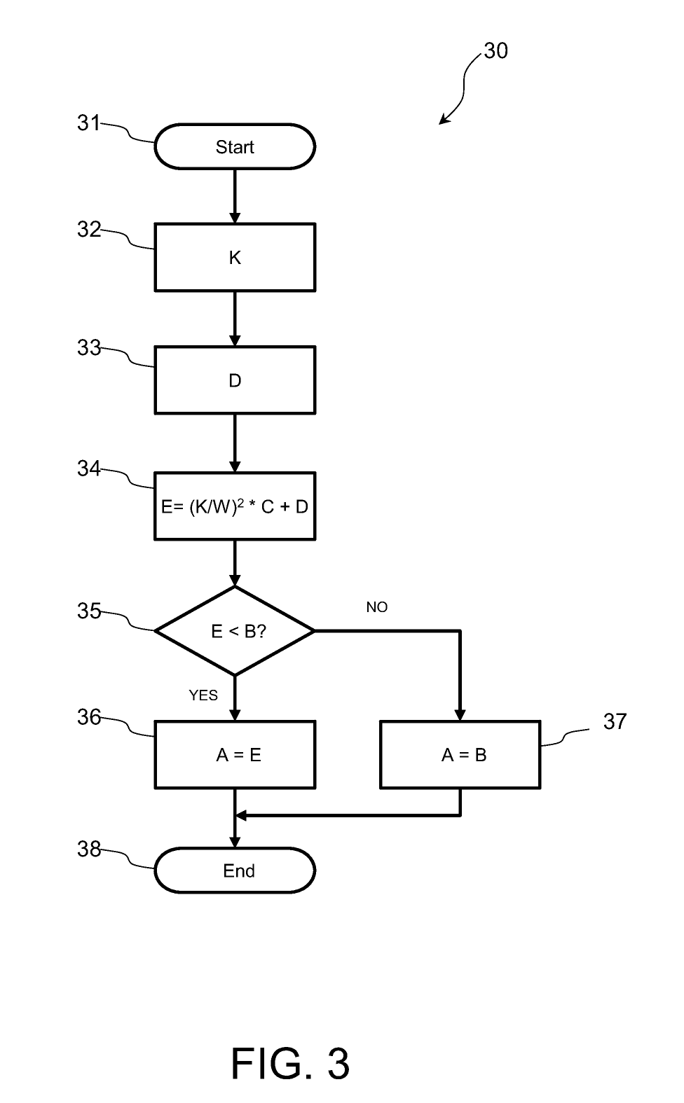

FIG. 1 outlines a motor vehicle 10 according to the present application by way of example. The motor vehicle 10 has at least one engine 11, a control unit 14, configured to carry out the control routine of FIG. 3, and an injection system 12. The fuel for operating the engine 11 may be stored in a fuel tank 15. The fuel tank 15 is connected in a fuel-conducting manner to the injection system 12 via a fuel line 17.

FIG. 1 shows a double-track motor vehicle 10 having four wheels 16 by way of example. The motor vehicle 10 may also be single-track and have a number of wheels 16 which differs from four. In addition, the packaging of the motor vehicle 10 may differ from the configuration which is shown.

According to the present application, the engine 11 is an internal combustion engine 11, in particular a reciprocating piston engine 11 with piston and crankshaft, which engine is configured so as to operate according to a spark-ignition principle.

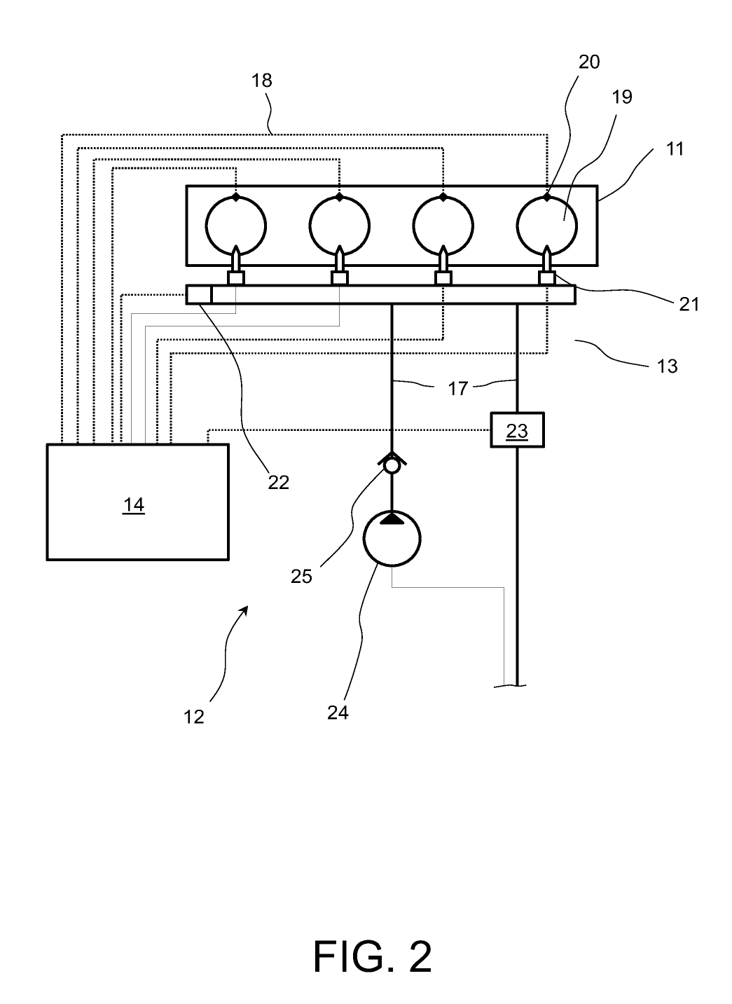

The control unit 14 is connected in a data-transmitting manner to the engine 11 and the injection system 12. Control unit 14 is shown receiving information from a plurality of sensors 26 and sending control signals to a plurality of actuators 27. This arrangement is shown in greater detail in FIG. 2, by way of example, in a detailed outline sketch, wherein the information is received and sent via data lines 18. As one example, sensors may include a pressure sensor 22 located on the fuel distribution rail 13 and a combustion chamber pressure sensor 20. As another example, the actuators may include a pressure control valve 23 and a fuel injection nozzle 21. The actuators may also include a fuel pump adjustment valve, such that the control system adjusts fuel pump operation, such as piston stroke, based on the various approaches described herein. The control unit 14 may include a controller including a processor and memory, not shown, wherein the controller may receive input data from the various sensors, process the input data, and trigger the actuators in response to the processed input data based on instruction or code programmed therein corresponding to one or more routines. An example control routine is described herein with regard to FIG. 3, which may be stored as instructions in memory in the controller.

Here, the engine 11 is shown by way of example as an in-line four-cylinder engine with four combustion chambers 19 which may be arranged in a row. The engine 11 has at least one combustion chamber 19. The engine is configured in such a way as for it to be possible to sense a current combustion chamber pressure D in the at least one combustion chamber 19. In particular, the engine 11 has at least one combustion chamber pressure sensor 20 for this purpose. As an alternative, the combustion chamber pressure D may be determined indirectly, for example via a stroke position of the piston and/or via an angular position of the crankshaft.

The injection system 12 comprises a fuel distribution rail 13, at least one injection nozzle 21 and a pressure unit. The pressure unit is formed, for example, from a pump 24, a pressure sensor 22 and a pressure control valve 23. Here, the fuel distribution rail 13 is connected hydraulically to the injection nozzle 21 in the pump 24 and the pressure sensor 22 and the pressure control valve 23. Fuel line 17 may serve for the hydraulic connection.

The injection system 12 is configured so as to inject fuel into the at least one combustion chamber 19. The injection system 12 is a direct injection system 12. Per combustion chamber 19, the injection system has at least one injection nozzle 21 which is connected to the fuel distribution rail 13. Here, the injection nozzle 21 is, in particular, a multiple-hole injection nozzle 21 which delivers the fuel into the combustion chamber 19 through a plurality of holes.

A fuel distribution rail pressure prevails in the fuel distribution rail 13 and in the at least one injection nozzle 21. The fuel which is to be delivered into the combustion chamber 19 is subjected to the fuel distribution rail pressure in the fuel distribution rail 13 and the at least one injection nozzle 21. During operation of the engine 11, the fuel is injected into the combustion chamber 19 by means of the fuel distribution rail pressure during opening of the injection nozzle 21. In one example, adjusting the fuel rail pressure to inject fuel into the combustion chamber 19 may be based on the minimum pulse width clipped to a maximum value.

The fuel distribution rail pressure is built up by the pump 24. The pump 24 may be a high-pressure pump 24. In addition, a non-return valve 25 may be arranged downstream of the pump 24, which non-return valve 25 prevents a flow of fuel in the opposite direction from the fuel distribution rail 13 into the pump 24. In one example, adjusting the fuel rail pressure is performed by adjusting the high pressure fuel pump outlet pressure. For example, the fuel rail pressure may be adjusted based on a pressure setpoint (e.g., based on a deviation of the current fuel rail pressure from the pressure setpoint), wherein the setpoint is based on the clipped minimum pulse width.

The fuel distribution rail pressure is determined by the pressure sensor 22. The fuel distribution rail pressure is set, for example, by the pressure control valve 23. If the pressure control valve 23 is opened, fuel may flow out of the fuel distribution rail 13 and the fuel distribution rail pressure may be reduced. The fuel distribution rail pressure may also be reduced by the operation of the injection nozzle 21 if, at the same time, a smaller quantity of fuel is conveyed into the fuel distribution rail 13 by the pump 24 than flows into the combustion chamber 19 through the injection nozzle 21.

The at least one combustion chamber pressure sensor 20, the at least one injection nozzle 21, the pressure sensor 22, and the pressure control valve 23 may be connected to the control unit 14 via data lines 18.

FIG. 3 shows a pressure determining method 30, which may be carried out by a controller of control unit 14, by way of example in a diagram from start 31 to end 38. The pressure determining method 30 determines the setpoint pressure A which is to prevail in the fuel distribution rail 13 for the following injection operation. The setting of the fuel distribution rail pressure to the setpoint pressure A may then subsequently be performed by the pressure unit of the injection system 12.

A calculation pressure E is determined in the pressure determining method 30 in a calculation pressure determination 34 on the basis of a predefined minimum permissible pulse width W, a required fuel mass to be injected, and a current combustion chamber pressure D. In addition, an equalization factor C may also be taken into consideration. In one example, the calculation pressure E may be output, at least temporarily, as setpoint pressure A.

In order to determine the calculation pressure E, in particular, a fuel mass component K is set in proportion to the pulse width W. The ratio of fuel mass component K and pulse width W is squared. The square of the ratio is added to the current combustion chamber pressure D.

In addition, the square of the ratio of fuel mass component K and pulse width W is provided with the equalization factor C. The product of the square of the ratio and the equalization factor C is then added to the current combustion pressure chamber D.

The minimum permissible pulse width W is predefined according to the design. The shortest time of opening of the injection nozzle 21 is determined by the minimum permissible pulse width W. In one example, the minimum pulse width is a minimum pulse width achievable by a fuel injector coupled to the fuel rail. Further, the minimum pulse width may be stored in the memory of a controller, and the controller may limit commanded fuel pulse width sent to one or more, or each, injector based on the stored value.

The fuel mass component K is determined in a fuel mass component determination 32. To this end, the required fuel mass to be injected is determined from a predefined characteristic diagram as a function of the instantaneous operating state of the engine 11. The fuel mass component K results from the entire fuel mass to be injected into the combustion chamber 19 during a single combustion chamber filling and the number of injection operations during said combustion chamber filling. The single combustion chamber filling may also be carried out by way of a plurality of injection operations of a single injection nozzle 21 or a plurality of injection nozzles 21. For example, the fuel mass to be injected K may be determined by the controller responsive to desired engine torque.

The equalization factor C is a predefined value or a predefined characteristic diagram. By way of the equalization factor C, the individual parameters of the engine 11 and the injection system 12, in particular of the injection nozzle 21, may be taken into consideration.

The combustion chamber pressure D is determined in a combustion chamber pressure determination 33, either directly by way of the combustion chamber pressure sensor 20 or indirectly, for example, via the stroke position of the piston which compresses the volume of the combustion chamber 19, or via the angular position of the crankshaft. For example, the current combustion chamber pressure may be determined based on valve timing and engine crankshaft position.

After the determination of the calculation pressure E in the calculation pressure determination 34, a setpoint pressure command 36, 37 takes place. Setting of the fuel distribution rail pressure may subsequently take place on the basis of the setpoint pressure command 36, 37.

The setpoint pressure A may be the calculation pressure E, for example the method may operate in a first mode. In a calculation pressure command 36, the calculation pressure E is then output as setpoint pressure A. In one example, during the first mode, the fuel rail pressure is adjusted based on a setpoint determined only from a minimum pulse width W, combustion chamber pressure D, and requested fuel mass K.

In addition, it is possible that a setpoint pressure check 35 is carried out before the setpoint pressure command 36, 37. A check is made here as to whether the calculation pressure E exceeds a maximum pressure B which specifies the maximum permissible fuel distribution rail pressure. As such, this may be a fixed setpoint. In one example, the maximum pressure B is a pressure setpoint which is based on the clipped minimum pulse width wherein clipping includes limiting the setpoint to a fixed maximum value. In another example, the pressure setpoint may be determined by a controller based on the minimum pulse width W, a required fuel mass to be injected K, and a current combustion chamber pressure D. For the case where the calculation pressure E is not smaller than the maximum pressure B, the method may operate in a second mode, wherein the maximum pressure B is then output as setpoint pressure A in a maximum pressure command 37. For example, during the second mode, the fuel rail pressure is adjusted based on a setpoint which is independent of the minimum pulse width W, combustion chamber pressure D, and requested fuel mass K. For example, during the second mode, the setpoint may be based on engine speed/load tables or calculations.

The setting of the fuel distribution rail pressure to the setpoint pressure A may subsequently take place by way of the control of the pressure unit. If the setpoint pressure A lies above the current fuel distribution rail pressure, which is detected by the pressure sensor 22, the pressure in the fuel distribution rail 13 is increased by the operation of the pump 24.

If the setpoint pressure A lies below the current fuel distribution rail pressure which is detected by the pressure sensor 22, the pressure control valve 23 may be opened and at the same time the operation of the pump 24 may be reduced. For the case where the pressure unit does not have a pressure control valve 23, the fuel distribution rail pressure may also be lowered solely by way of the reduction of the operation of the pump during the injection of fuel into the combustion chamber 19. If a rapid reduction of the fuel distribution rail pressure is considered, the air filling may additionally be lowered in a less rapid manner by way of slower closing of a throttle valve. The injected fuel quantity is increased as a result and the fuel distribution rail pressure may drop more rapidly.

The pressure determining method 30 may be controlled by the control unit 14. For example, the control unit may select an operating mode. As an example, the engine controller may select a first mode and during the first mode, the controller may adjust a fuel rail pressure based on a setpoint determined only from a minimum pulse width, combustion chamber pressure, and requested fuel mass. When the setpoint determined in the first mode reaches a fixed setpoint, the controller may transition to operating in a second mode. Therein, during the second mode, the fuel rail pressure may adjusted based on the fixed setpoint independent of the minimum pulse width, combustion chamber pressure or requested fuel mass.

In this way, injection nozzle coking is reduced and exhaust particulate emissions are lowered.

Note that the example control and estimation routines included herein can be used with various engine and/or vehicle system configurations. The control methods and routines disclosed herein may be stored as executable instructions in non-transitory memory. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations, and/or functions may graphically represent code to be programmed into non-transitory memory of the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A pressure determining method comprising:
determining a setpoint pressure in a fuel distribution rail of an injection system of a motor vehicle,
a calculation pressure being determined from a sum of a combustion chamber pressure and a square of a ratio of a fuel mass component and a pulse width; and
the calculation pressure being output at least temporarily as setpoint pressure.

2. The pressure determining method of claim 1, comprising:
the calculation pressure being compared with a maximum pressure;
the calculation pressure being output as setpoint pressure in the case where the calculation pressure is lower than the maximum pressure; and
the maximum pressure being output as setpoint pressure in the case where the calculation pressure is greater than or equal to the maximum pressure.

3. The pressure determining method of claim 1, wherein the ratio of the fuel mass component and the pulse width is provided with an equalization factor.

4. A method, comprising:
adjusting a fuel rail pressure based on a minimum pulse width clipped to a maximum value.

5. The method of claim 4, where the fuel rail pressure is adjusted based on a pressure setpoint, the setpoint based on the clipped minimum pulse width.

6. The method of claim 5, wherein the minimum pulse width is a minimum pulse width achievable by a fuel injector coupled to the fuel rail, the minimum pulse width stored in memory of a controller.

7. The method of claim 5, wherein the setpoint is determined by a controller based on the minimum pulse width, a required fuel mass to be injected, and a current combustion chamber pressure.

8. The method of claim 7, wherein the required fuel mass to be injected is determined by the controller responsive to desired engine torque.

9. The method of claim 8, wherein the current combustion chamber pressure is determined based on valve timing and engine crankshaft position.

10. The method of claim 9, wherein adjusting the fuel rail pressure is performed by adjusting a high pressure fuel pump outlet pressure.

11. The method of claim 10, wherein clipping includes limiting the setpoint to a fixed maximum value.

12. A method, comprising:
during a first mode, adjusting a fuel rail pressure based on a setpoint determined only from a minimum pulse width, combustion chamber pressure, and requested fuel mass; and
during a second mode, adjusting the fuel rail pressure based on a setpoint independent of the minimum pulse width, combustion chamber pressure, and requested fuel mass.

13. The method of claim 12, wherein the second mode is selected based on the setpoint determined in the first mode reaching the fixed setpoint.

14. The method of claim 12 wherein the setpoint independent of the minimum pulse width, combustion chamber pressure, and requested fuel mass, is based on engine speed.
